(19) United States
(12) Patent Application Publication
(10) Pub. No.: US 2009/0116210 A1
(43) Pub. Date: May 7, 2009

(54) DEVICE FOR INTELLIGENT ILLUMINATION

(76) Inventors: Shaun CUTLER, Ashington (GB); Tony Whiting, Ashington (GB); David Lambert, Ashington (GB)

Correspondence Address: Pearl Cohen Zedek Latzer, LLP, 1500 Broadway, 12th Floor, New York, NY, 10036, US

(21) Appl. No.: 12/263,579

(22) Filed: Nov. 3, 2008

Related U.S. Application Data
(63) Continuation-in-part of application No. 11/729,979, filed on Mar. 30, 2007.

(30) Foreign Application Priority Data
Nov. 2, 2007 (GB) 0721545.2

(51) Int. Cl. G03B 15/02

(52) U.S. Cl. 362/8

(57) ABSTRACT

There is disclosed an adaptive illumination device comprising at least one lighting panel bearing an array of light emitters, and control means for selectively energising predetermined groups of light emitters within the array in response to control signals so as to illuminate a predetermined part of a scene.

### RELATED APPLICATION DATA

The present application is a continuation-in-part of prior U.S. application Ser. No. 11/729,979, entitled “ADAPTIVE ILLUMINATION LIGHTING SYSTEM”, FILED Mar. 30, 2007, which in turn claims priority from prior UK application 0606371.3, filed Mar. 20, 2006, each of which being incorporated by reference herein in their entirety. The present application also claims priority from prior UK application 0721545.2, filed Nov. 2, 2007, incorporated by reference herein in its entirety.

### FIELD OF THE INVENTION

The present invention relates to lighting solutions for, for example, surveillance and CCTV systems.

### BACKGROUND

Few will suggest that CCTV is not a valuable tool in the fight against crime, but many surveillance systems fail to provide a useful picture because of poor lighting solutions. Existing lighting solutions struggle to provide the flexibility and critically the flexible illumination requirements that the CCTV camera and lens require. Lighting can be a powerful deterrent.

During the day ambient sunlight may provide sufficient illumination to provide high quality even illumination CCTV images. However during the more vulnerable hours of darkness these cameras may fail to provide high quality CCTV without adequate illumination.

Traditional illuminators have a fixed beam angle which can not be altered to match the view of the camera and remain constant in both intensity and angle.

### SUMMARY

This invention relates to, in one embodiment, an illumination system that may adapt both the intensity and direction of light dependant upon activity within the scene. The illumination system may work in conjunction with CCTV cameras, notably (but not exclusively) with smart CCTV cameras. More specifically, certain embodiments of the invention refer to a solid-state light emitting diode (LED) illumination product that provides adaptable illumination across the horizontal landscape with the ability to switch on and adjust (intensify or decrease) the LED illumination. The angle of illumination can be adjusted to provide a wider or narrow angle of illumination over a chosen area to match with field of view of the CCTV lens/camera.

The system is designed primarily (but not exclusively) for surveillance purposes. This invention relates specifically to using light in an intelligent manner to both provide an image for the CCTV camera and a visible targeted light. This has several benefits;

a. Deterrent lighting
b. Energy saving
c. Reduction in light pollution
d. Clear color CCTV images

Embodiments of this invention provide the required illumination provided primarily (but not exclusively) by LED sources (for example, white-light LED sources, but other colors or wavelengths, including those not in the visible spectrum, may be employed) and allows the beam pattern to be matched to the scene requirements with the ability to direct the light and intensity dependent upon activity.

According to one embodiment the present invention, there is provided an adaptive illumination device comprising at least one lighting panel bearing an array of light emitters, and control means for selectively energising predetermined groups of light emitters within the array in response to control signals so as to illuminate a predetermined part of a scene.

In preferred embodiments, each lighting panel comprises a housing with a panel or matrix of light emitters provided on a frontal surface thereof. The light emitters may be LEDs or other light emitters, and may emit visible or infra-red or other light.

These light emitters may be switched on and off in groups or clusters so as to provide a range of different beam patterns

A primary function of the invention is to provide visible illumination that can adjust with the dynamics of the scene.

In some embodiments, there may be provided at least first and second lighting panels connected to each other by way of a hinge mechanism.

Where only two lighting panels are provided, these may be further provided with a gear mechanism such that angular movement of the first lighting panel about the hinge causes equivalent angular movement of the second lighting panel in an opposite direction about the hinge.

Alternatively, three or more lighting panels may be provided, each panel facing in a different direction. The panels may be connected to each other by hinge mechanisms, optionally in conjunction with gear mechanisms so that the panels may pivot in concert about their respective hinges.

Conventional light sources provide a fixed angle of illumination that does not adapt to the scene. This means that when installed with CCTV cameras the light will not change as a subject moves across a scene, nor does the light always match the angle of view of the lens. This invention allows for the light source angle to be adapted in accordance with the chosen scene and importantly the activity.

Embodiments of the invention, in addition to providing an electronic solution to allow the light to be controlled, may also provide a mechanical solution to allow the light to be adjusted dependent upon requirements.

The electronic system allows clusters of illumination to be controlled in terms of direction and intensity. The matrix of light emitters is matched up to the output of a CCTV camera or DVR or software package that effectively signals to the matrix when to switch on a particular cluster of light emitters. The result is that the light can effectively follow the subject across the scene.

The optional mechanical system comprises at least two elements which enable the installer to correctly install the lamps and match the field of view of the lens.

Mechanical control is achieved in certain embodiments by dividing the lighting unit into two separate halves which can be moved in conjunction with each other in a horizontal plane—thereby providing mechanical control over the horizontal beam distribution. A series of cogs/pivots will ensure that the two units can be smoothly and easily adjusted together with markers showing the angle of displacement from each other (below).

### BRIEF DESCRIPTION OF THE DRAWINGS

For a better understanding of the present invention and to show how it may be carried into effect, reference shall now be made by way of example to the accompanying drawings, in which:

FIGS. 1 and 2 show an embodiment of the present invention;

FIGS. 3 and 4 show a cog and bracket mechanism of the embodiment of FIG. 1;

FIG. 5 shows a key for use with the embodiment of FIGS. 1 and 2;

FIG. 6 shows, in schematic form, a range of illumination angles;

FIGS. 7(a) and 7(b) respectively show an intensity curve of a prior art illuminator and a corresponding image on a CCTV monitor showing a scene illuminated by the prior art illuminator;

FIGS. 8(a) and 8(b) show a comparison of a scene illuminated by a prior art illuminator and an illuminator of an embodiment of the present invention;

FIGS. 9(a) and 9(b) respectively show an intensity curve of an illuminator of an embodiment of the present invention and a corresponding image on a CCTV monitor showing a scene illuminated by the illuminator of an embodiment of the present invention;

FIG. 10 shows a varifocal lens of a camera for use with embodiments of the present invention;

FIG. 11 shows a VDU image of a scene that is being monitored with an embodiment of the invention;

FIG. 12 shows a VDU image with split screen representing allowing detection of movement with different parts of the scene; and

FIG. 13 shows how the light emitted by embodiments of the present invention can adjust to the dynamics of the scene via a matrix or cluster of lights.

### DETAILED DESCRIPTION

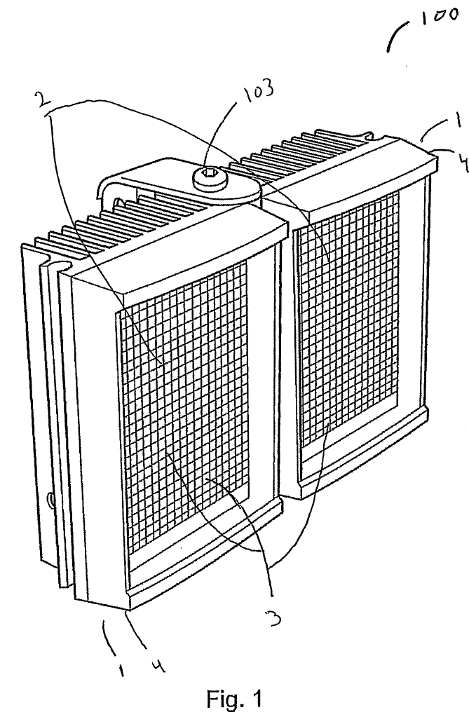

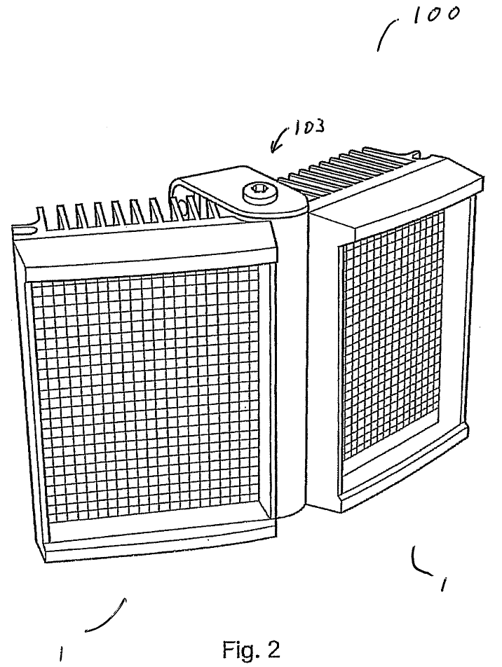

FIGS. 1 and 2 show a first embodiment of the present invention comprising an illumination device 100 comprising two lighting panels 1 moveable at a hinge 103, each panel 1 bearing an array 2 of light emitters 3, and control means for selectively energising predetermined groups or subsets of light emitters 3 within the array 2 in response to control signals so as to illuminate a predetermined part of a scene.

Each lighting panel 1 comprises a housing 4 with a panel or matrix 2 of light emitters 3 provided on a frontal surface thereof. The light emitters 3 may be LEDs or other light emitters, and may emit visible or infra-red or other light.

These light emitters 3 may be switched on and off in groups or clusters so as to provide a range of different beam patterns, thus providing electronic control of a lighting pattern.

Mechanical control is achieved by dividing the lighting unit into two separate halves which can be moved in conjunction with each other in a horizontal plane—thereby providing mechanical control over the horizontal beam distribution (see FIG. 2). A series of cogs/pivots will ensure that the two units can be smoothly and easily adjusted together with markers showing the angle of displacement from each other (below). Also, the mechanical design of the adaptive illumination concept means that several units can be joined together—all with independent horizontal control.

FIGS. 1 and 2 illustrate the mechanical aspects of the adaptable illumination feature allowing angles to be altered. The solution is primarily a cogged mechanical solution that allows the user to select a beam pattern in accordance with the scene. The cogs below highlight a small arrow that indicates the selected beam pattern. The cogs and arrow can be used by the installer to ensure that the angle of illumination matches the field of view of the lens. This is particularly useful when using infra-red since the illumination can not be seen by the human eye.

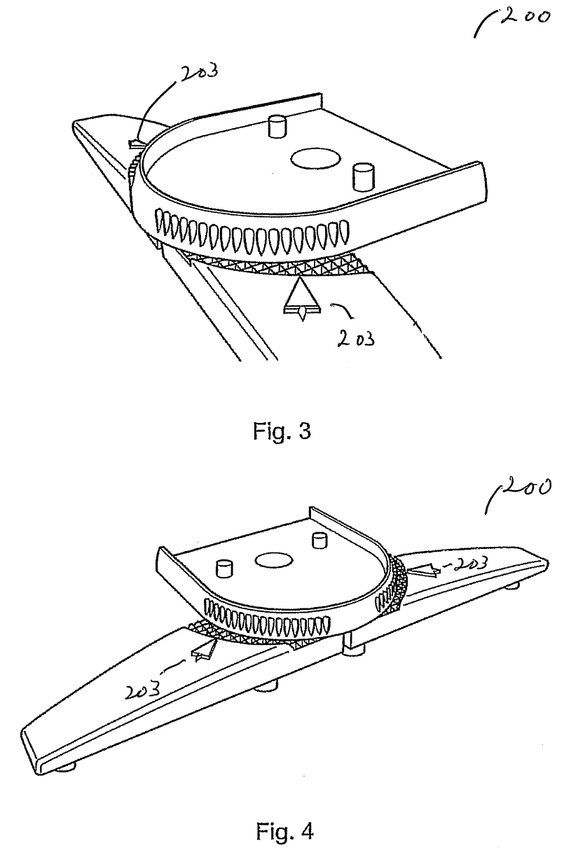

A bracket and cog system 200 is shown in FIGS. 3 and 4, and comprises a uniquely designed set of cogs and bracketry with indicators 203 which show the angle of light emitted from the lamp. This is particularly useful when setting up Infra Red systems with cameras—since the Infra Red is not visible during the day when most installations are undertaken. The cogs and indicators are specifically calibrated for the needs of the CCTV installer and are designed to be compatible with, and provide coverage for, available varifocal lenses.

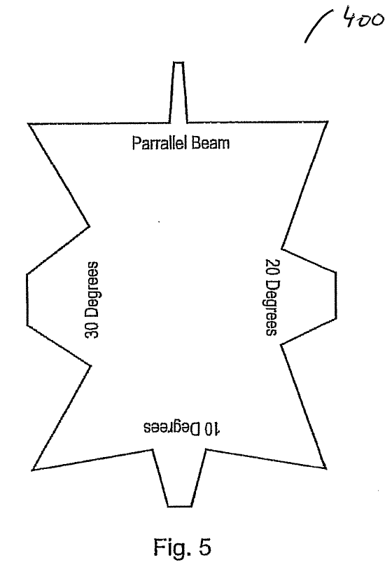

In addition to the bracket and cog system of FIGS. 3 and 4, there may be provided an adaptive illumination key (FIG. 5, 400) which enables the installer to check and/or set the beam angle by inserting the key between the cogs. Again, this is invaluable for setting up Infra Red systems during the day since the Infra Red illumination is not visible to the human eye.

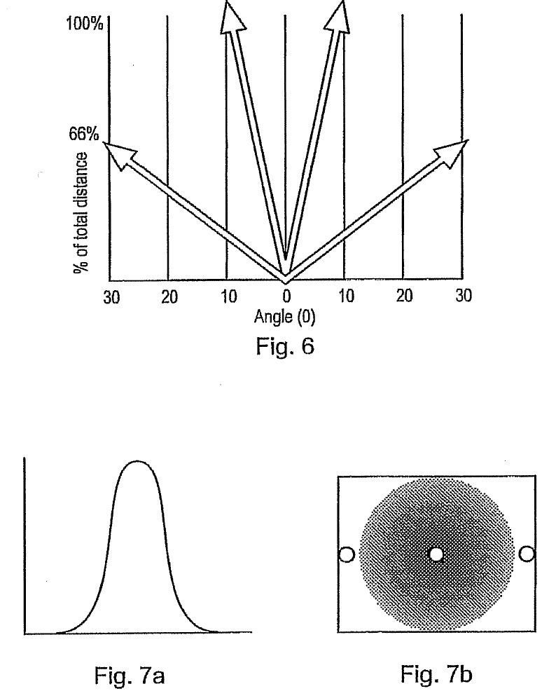

FIG. 6 illustrates the flexibility provided by the adaptive illumination feature. The example shown here demonstrates the possible illumination patterns from a 20-60 degree adaptive illumination product.

With reference to FIGS. 7(a) and 7(b), illumination from a traditional lighting system produces a fixed beam pattern that often results in a single intensified fixed spot.

FIG. 7(a) shows the output from a traditional illuminator, with a single beam having a high central peak intensity of light.

FIG. 7(b) is a representation of the output shown in FIG. 7(a) when projected onto a scene and the scene viewed on a CCTV monitor. The illumination does not cover the whole scene, with the middle subject being over illuminated and outside subjects being under illuminated or not illuminated at all. In FIG. 7(b), the representation is polarised to demonstrate intensity in the centre of the CCTV monitor with a 4×3 aspect ratio. The effect can create a vignette leaving the outside corners dark (non-polarised) and the centre point over illuminated.

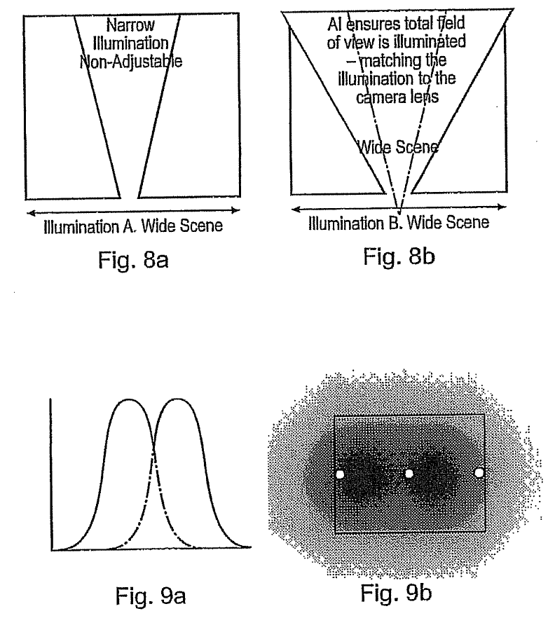

With reference to FIG. 8(a), this shows a scene illuminated by a known fixed beam illuminator which cannot adjust to accommodate a wider field of view. FIG. 8(b) shows an embodiment that has been set to illuminate a wide scene by moving the lighting units about the hinge so as to illuminate a wider field of view. Additionally a fixed narrow beam will cause glare and white out on a wide scene, conversely a fixed wide beam on a narrow scene results in wastage and unnecessary light pollution (visible illumination only). The flexibility of embodiments of the present invention allows the beam to adjust to the scene reducing glare and white out whilst ensuring that no light is wasted or creating unnecessary light pollution.

FIGS. 9(a) and 9(b) may be compared with FIGS. 7(a) and 7(b), and show an application of an embodiment of the invention.

As shown in FIG. 9(a), a beam pattern created by present embodiments creates a less intense central beam and instead distributes the intensity out to the outer limits of the scene, this being shown in FIG. 9(b) as a CCTV image of the scene illuminated by the beam pattern of FIG. 9(a).

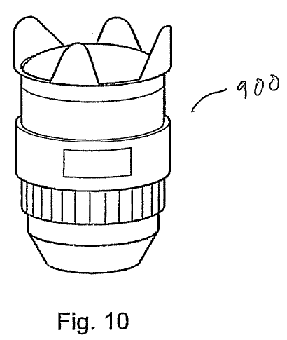

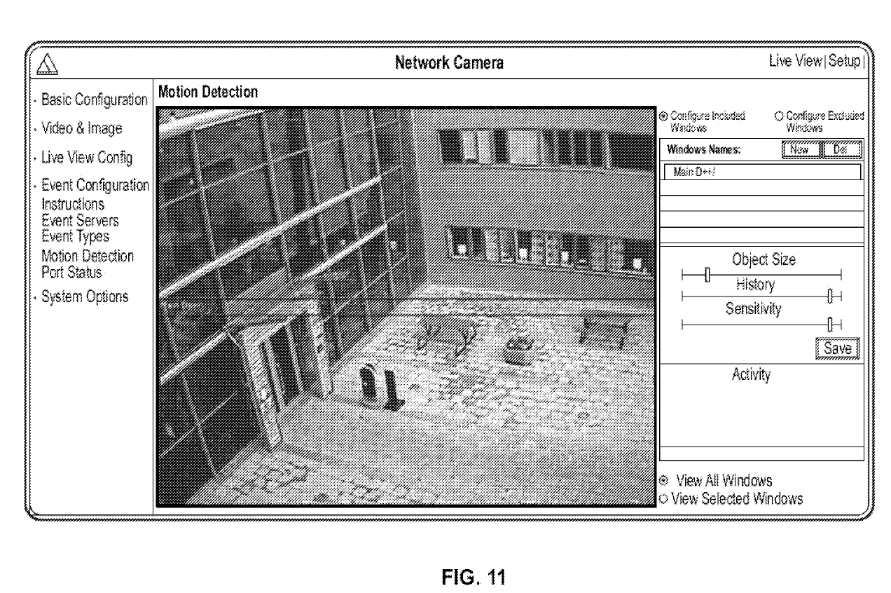

In simple terms the flexibility allows the light to match the angle of illumination to the angle of view from varifocal CCTV lens 900 as shown in FIG. 10.

FIG. 11 shows a computer display screen on which is displayed a scene recorded by a CCTV camera. Various sections of the image on the screed can be selected by a user, and the lighting unit will then be controlled electronically and, optionally, mechanically, to best illuminate the selected sections. In addition to manual operation by a user, sections of the scene may be automatically selected, for example if movement or other triggers are detected. In preferred embodiments, the illumination device 1 can be sufficiently finely controlled, electronically and optionally mechanically, to create lighting that follows a subject or individual within the scene.

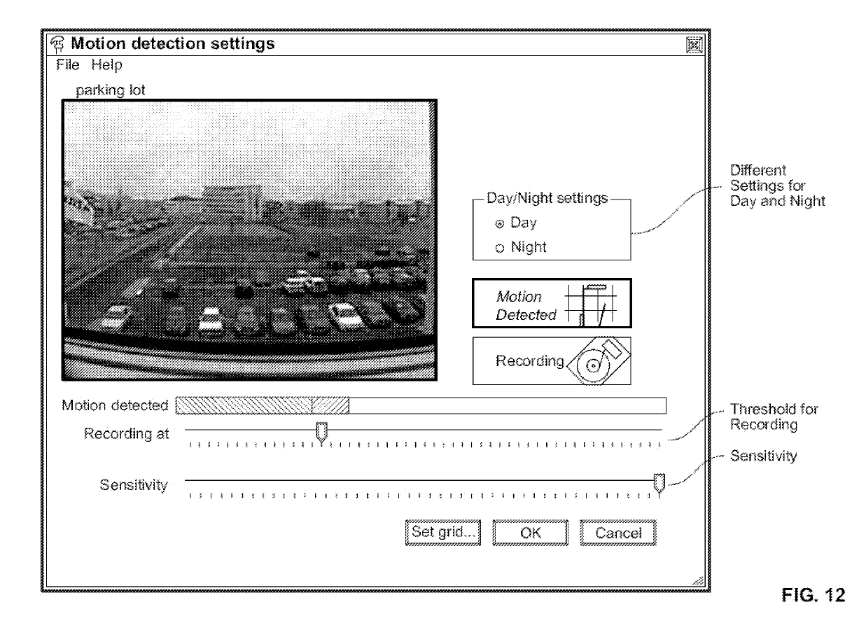

FIG. 12 shows an alternative computer display illustrating how illumination can be adjusted to the dynamics of a scene via a matrix or cluster of lights. Different settings may be used for day and night operation, and a recording threshold set based on a degree of detected movement within the scene. A sensitivity of detection can also be adjusted.

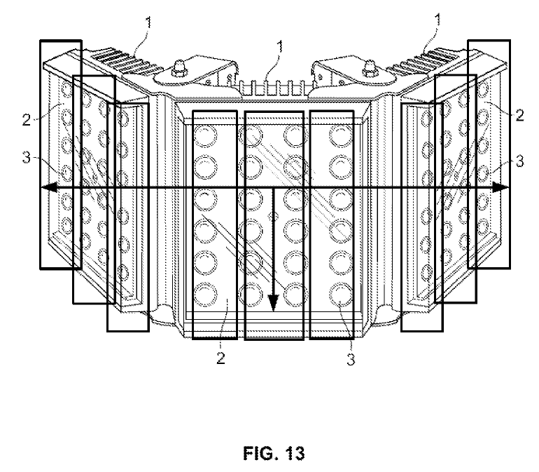

FIG. 13 shows an alternative embodiment of the illumination device comprising three panels 1, each with an array 2 of light emitters 3. The panels 1 can be directed and operated to provide dynamic, directional lighting up to 180 degrees. A computer processor can control each section of the light in both intensity (for example by way of adjustable power to the LEDs) and direction, as well as by selectively energising groups or subsets of LEDs.

The design of preferred embodiments will ensure that various angles of horizontal and/or vertical spread can be achieved from a single product.

The design of preferred embodiments enables the angle of illumination to be changed and matched to the changeable field of view of varifocal lenses.

The design of preferred embodiments will ensure that a more suitable horizontal and/or vertical illumination is provided over the chosen area

The design of preferred embodiments will ensure that a more even illumination pattern and a more useable CCTV picture is provided.

An Adaptive Illumination (AI) Control System of present embodiments may be used with camera based vision systems for example, but not exclusively, Closed Circuit Television Systems, Machine Vision Systems, and Broadcast lighting systems.

Adaptive Illumination is primarily designed to provide vari-focal flexibility and help to provide correctly illuminated camera images.

In some embodiments, this is a mechanical control system to control the light output of illumination systems specifically designed for camera based vision systems.

Particularly preferred embodiments relate to LED based lighting systems for CCTV.

In summary the flexibility derived from vari-focal lens in CCTV and Photography terms can now be matched with flexibility in CCTV lighting.

Throughout the description and claims of this specification, the words “comprise” and “contain” and variations of the words, for example “comprising” and “comprises”, means “including but not limited to”, and is not intended to (and does not) exclude other moieties, additives, components, integers or steps.

1. An adaptive illumination device comprising at least one lighting panel bearing an array of light emitters, and control to selectively energise predetermined groups of light emitters within the array in response to control signals so as to illuminate a predetermined part of a scene.

2. A device as claimed in claim 1, wherein each lighting panel comprises a housing with a panel of light emitters provided on a frontal surface thereof.

3. A device as claimed in claim 1, wherein the light emitters are light emitting diodes.

4. A device as claimed in claim 1, wherein the light emitters are configured to emit visible light.

5. A device as claimed in claim 1, wherein the light emitters are configured to emit infra-red light.

6. A device as claimed in claim 1, wherein the light emitters are configured to be switched on and off in different groups or clusters so as to provide a range of different beam patterns

7. A device as claimed in claim 1, comprising at least first and second lighting panels connected to each other by way of a hinge mechanism.

8. A device as claimed in claim 7, comprising first and second lighting panels provided with a gear mechanism such that angular movement of the first lighting panel about the hinge causes equivalent angular movement of the second lighting panel in an opposite direction about the hinge.

9. A device as claimed in claim 1, comprising three or more lighting panels, each panel facing in a different direction.

10. A device as claimed in claim 9, wherein the panels are connected to each other by hinge mechanisms.

11. A device as claimed in claim 10, wherein the panels are provided with gear mechanisms so that the panels may pivot in concert about their respective hinges.

12. A device as claimed in claim 1, wherein the array of light emitters is matched up to the output of a unit that signals to the array when to switch on a particular cluster of light emitters, the unit being selected from the group consisting of: a CCTV camera, a DVR and a software package

13. A device as claimed in claim 1, comprising a camera.

14. A device as claimed in claim 13, wherein the camera is a video camera.
